(19) United States
(12) Patent Application Publication
(10) Pub. No.: US 2025/0115528 A1
(43) Pub. Date: Apr. 10, 2025

(54) Microbial-Embedded Hydrogel Beads and Methods of Use

(71) Applicant: University of Washington, Seattle, WA (US)

(72) Inventors: Mari-Karoliina Henriikka Winkler, Seattle, WA (US); Korena Mafune, Seattle, WA (US)

(73) Assignee: University of Washington, Seattle, WA (US)

(21) Appl. No.: 18/725,318

(22) PCT Filed: Jan. 5, 2023
(86) PCT No.: PCT/US2023/060180

§ 371 Date: Jun. 28, 2024

Related U.S. Application Data
(60) Provisional application No. 63/297,549, filed on Jan. 7, 2022.

(51) Int. Cl. C05F 11/08; A01N 25/26; A01N 63/20; A01N 63/30; A01P 21/00; C05G 5/35; C09K 17/00

(52) U.S. Cl. CPC C05F 11/08; A01N 25/26; A01N 63/20; A01N 63/30; A01P 21/00; C05G 5/35; C09K 17/00

(57) ABSTRACT

Embodiments of the present disclosure provide compositions and methods for increasing nutrient uptake by plants and for effecting soil remediation. Embodiments of the composition and methods comprise a hydrogel bead, a microbial consortia, and a fungi, and can additionally comprise an excipient for administration of the hydrogel bead comprising the microbial consortia and the fungi, one or more seed, water, one or more nutrients, and combinations thereof. Such composition and methods have broad application to reduce fertilizer requirements and use, and to increase plant nutrient access and uptake. The composition and methods have additional application to remediate contaminated mediums such as soil contaminated with chemicals, petroleum, and explosives.

### CROSS-REFERENCE TO RELATED APPLICATION

This application claims the benefit of U.S. Provisional Patent Application No. 63/297,549, filed on Jan. 7, 2022, the contents of which are hereby incorporated by reference in their entirety.

### BACKGROUND

Crops must feed the burgeoning world population and provide biomass for alternative energy such as ethanol. In 2019, in one U.S. state alone, Hordeum vulgare L. (barley), Zea mays convar. Saccharata var. rugose (sweet corn), and Triticum aestivum L. (wheat) had a production value of $26,754,00, $85,806,000, and $790,976,000, respectively.

Both nitrogen (N) and phosphorus (P) fertilization are currently indispensable for high yield crop production. Synthetic N fertilizers currently feed >50% of the world population, and the use of P fertilizers has increased ˜5-fold since the 1960's. However, the sourcing and production of N and P fertilizers is unsustainable and alternative practices are needed.

For example, industrial N-production consumes ˜2% of all energy used on earth and the process emits ˜1% of global CO₂, which exceeds all other industrial chemical-making reactions. Most P fertilizers are made from mined rock phosphate, a finite resource that poses socioeconomic issues with geopolitical restraints. For example, 5 countries house ˜90% of the world's rock phosphate supply, creating a global imbalance.

Unfortunately, the negative impacts of N and P fertilizers are not limited to the sourcing and production of these products because the excessive application of these fertilizers to enhance crop yield has cascading effects on the environment. When N and P fertilizers are applied to agricultural soils, more than half of the applied N and P go unused by crops.

One contributing factor for the low efficacy of P fertilizers is that a majority gets bound to soil particles in forms that are inaccessible to plants. Additionally, most crops are inefficient in the acquisition and uptake of N and P fertilizers, resulting in low nitrogen use efficiency (NUE) and phosphorus use efficiency (PUE). Excessive fertilizer application paired with low NUE and PUE has resulted in environmental damage through N and P leaching, leading to contamination of groundwater resources and surface water eutrophication.

This has resulted in environmental damage estimated to exceed costs of $2.2 billion annually, in the US alone. In addition, N fertilizer use leads to the largest source of anthropogenic nitrous oxide (N₂O) emission. Given the large global warming potential of N₂O (about 300 CO₂ equivalents) over a 100-year time horizon, even small quantities of this potent greenhouse gas (GHG) can impact the global carbon footprint from agricultural systems.

It is predicted that the application and associated energy consumption of synthetic N fertilizers must be increased 3-fold to meet the food and energy demands of the growing population. However, the negative impacts of these fertilizers are already apparent and will be exacerbated by climate change. For example, it is predicted that N leaching from agricultural soils to aquatic systems will increase by ˜19% by the end of the century by climate induced precipitation increases. In order to offset this, soil N inputs would need to be reduced massively.

It is estimated that P fertilizer application will need to increase 51-86% by 2050 to sustain crop growth for the population, but conflictingly would need to decrease by 20-80% to counter the projected P losses associated with climate induced precipitation increases. Unfortunately, the run-off and leaching of P are a main driver of surface-water eutrophication, resulting in toxic algal blooms, decreased biodiversity (including fish kills that impact food harvest), and drinking water contamination. This can be directly related to the excessive addition of P fertilizers and low plant PUE. Aside from leaching, there are other issues associated with the application of P fertilizers. For example, there is often enough residual P in soils, that if it were to become available, there would be enough to support plant uptake for years. Unfortunately, instead of finding sustainable approaches to release immobilized P that is already present, more fertilizer is added.

In addition, soil contamination and the associated costs are not limited to applied fertilizers. Contamination of soil and other mediums arises from other applied and natural sources as well, such as chemicals, petroleum, explosives, and radioactive agents.

Soil contamination by chemicals aside from fertilizers include byproducts of industrial activities, municipal wastes, petroleum products, acid rain, and applied herbicides and pesticides. An estimated one third of terrestrial soils are currently impacted by chemical pollution and other soil degradation, affecting approximately 3.2 billion people. It takes approximately 1,000 years to form a new 1 cm depth of topsoil, and soil regeneration processes pose challenges.

Explosives contaminate approximately 50 million acres of land in the U.S. alone, owing to bombing and other training activities, with an even greater land area estimated to be contaminated in Europe and Asia. Explosives such as 2,4,6-trinitrotoluene (TNT), hexahydro-1,3,5-trinitro-1,3,5-triazine (RDX), and octahydro-1,3,5,7-tetranitro-1,3,5,7-tetrazocine (HMX), and the propellant ingredients nitroglycerin (NG), nitroguanidine (NQ), nitrocellulose (NC), 2,4-dinitrotoluene (2,4-DNT), and perchlorate are of particular concern.

Radioactive contamination arises from inadequate disposal practices, accidental release, and nuclear weapons testing and use, as well as naturally-occurring radioactive materials from industrial activity such as mining, oil and gas production, production of certain metals, and the phosphorus fertilizer industry.

The application of bacteria to soils and/or plants can improve growth of plants or crops. For example, diazotrophic bacteria employ N-fixation to provide N food to a plant by converting N₂ gas from the air into a form capable of metabolism by the plant. Another group of bacteria is nitrifiers which are important soil consortia which oxidize ammonium to nitrate, through the intermediate nitrite. The major terrestrial nitrifiers are ammonium oxidizing archaea (AOA), which are ubiquitous in oligotrophic environments and produce low amounts of N₂O. In contrast, ammonium oxidizing bacteria are prevalent in ammonium laden (fertilized) soils and emit more N₂O than AOA. Improved nitrogen uptake efficiency (NUE) would result in decreased N fertilizer application requirements. This could favor AOA, and result in decreased N₂O emissions.

A technology which solves plant nutrient uptake and soil contamination problems would have diverse applications. These include protecting national food security, avoidance of catastrophic crop loss through drought events, decreased use of synthetic fertilizers applied to agricultural systems, nontraditional solutions to expand crop production in extreme environment soils considered unfavorable for agriculture or biofuel production, and remediation of soil and other mediums.

Therefore, a need exists to decrease fertilizer application rates, promote plant N and P uptake while maintaining enhanced crop growth, and remediate contaminated soils.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, an inoculant composition comprises a hydrogel bead, a microbial consortia, and a fungi, wherein the microbial consortia and the fungi are in contact with the hydrogel bead. The hydrogel bead is comprised of an amount effective to contact the microbial consortia and the fungi, and can be either biodegradable or not biodegradable. The microbial consortia comprises one or more bacteria, one or more archaea, or a combination thereof, wherein the more than one bacteria and/or archaea can be either the same or different. The fungi comprises arbuscular mycorrhizal fungi, ectomycorrhizal fungi, ericoidal mycorrhizal fungi, plant growth promoting fungi, decomposer fungi, or a combination thereof. The inoculant composition can further comprise an excipient for administering the hydrogel beads, one or more nutrients or nutrient substrates, water, one or more seed, or a combination thereof.

In another aspect, a method for increasing nutrient acquisition in a plant in need thereof comprises: first, generating an inoculant composition for treatment of a plant, part of a plant, medium in contact with a plant, or a combination thereof, wherein the inoculant composition comprises an effective amount of a hydrogel bead, an effective amount of a microbial consortia, and an effective amount of a fungi, and wherein the microbial consortia and the fungi are in contact with the hydrogel bead; and second, applying the inoculant composition to the plant, part of the plant, medium in contact with the plant, or a combination thereof, or a medium in proximity to a plant wherein the plant can access the inoculant composition from the medium.

In yet another aspect, a method for degrading one or more chemical compounds from a medium comprising a chemical compound contaminant comprises: first, generating an inoculant composition for a treatment of a medium in need thereof, wherein the inoculant composition comprises an effective amount of a hydrogel bead, an effective amount of a microbial consortia, and an effective amount of a fungi, wherein the microbial consortia and the fungi are in contact with the hydrogel bead; and second, applying the inoculant composition to the medium in need thereof, wherein the inoculant composition contacts the medium.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 shows the average percentage of potentially infective beads (% PIB) for the three arbuscular mycorrhizal fungal (AMF) species (Rhizophagus intraradices, R. irregularis, and Funneliformis mosseae) averaged across the four AMF species-specific strains. The bars denote standard error. On day 14, the % PIB significantly differed across the three AMF species (F=8.22, P<0.05) with R. intraradices demonstrating the highest % PIB (64.3% ±2.8), followed by R. irregularis (45.5% ±5.6) and F. mosseae (40.3% ±4.3).

FIG. 2A shows the average percentage of potentially infective beads (% PIB) for the four species-specific strains of Rhizophagus intraradices. At the end of the incubation (day 14), no differences were observed in % PIB among R. intraradices strains (X²=4.88, P=0.18). The vertical grey dashed line on day 4 denotes the time point that all PIB had visible colonies of A. brasilenses Sp7.

FIG. 2B shows the average percentage of potentially infective beads (% PIB) for the four species-specific strains of Rhizophagus irregularis. At the end of the incubation (day 14), germination success was different among species-specific strains of R. irregularis (X²=16.32, P<0.05). The vertical grey dashed line on day 4 denotes the time point that all PIB had visible colonies of A. brasilenses Sp7.

FIG. 2C shows the average percentage of potentially infective beads (% PIB) for the four species-specific strains of Funneliformis mosseae. At the end of the incubation (day 14), germination success was different among species-specific strains of F. mosseae (X²=9.35, P<0.05). The vertical grey dashed line on day 4 denotes the time point that all PIB had visible colonies of A. brasilenses Sp7.

FIG. 3A shows successfully germinated arbuscular mycorrhizal spores of Rhizophagus intraradices, with hyphal branching and germ tube elongation (black arrows “a” and “b”) in hydrogel beads (* marks edge of beads) and active bacterial A. brasilenses Sp7 (diazotrophic PGPB) colony growth (white arrow). The microscope image was taken on day 6 of incubation.

FIG. 3B shows successfully germinated arbuscular mycorrhizal spores of R. irregularis, with hyphal branching and germ tube elongation (black arrows “a” and “b”) in hydrogel beads (* marks edge of beads) and active bacterial A. brasilenses Sp7 (diazotrophic PGPB) colony growth (white arrow). The microscope image was taken on day 6 of incubation.

FIG. 3C shows successfully germinated arbuscular mycorrhizal spores of Funneliformis mosseae, with hyphal branching and germ tube elongation (black arrows “a” and “b”) in hydrogel beads (* marks edge of beads) and active bacterial A. brasilenses Sp7 (diazotrophic PGPB) colony growth (white arrow). The microscope image was taken on day 6 of incubation.

FIG. 4 shows wheat plants that received no hydrogel biofertilizer (left) and wheat plants that did receive hydrogel biofertilizer (right). The treated wheat plants were larger, had higher leaf count, and did not show signs of nutrient deficiency.

FIG. 5 shows a wheat plant treated with hydrogel biofertilizer (right) compared with a wheat plant that did not receive the biofertilizer (left). The treated plant was taller, developed more leaves, and appeared more robust than the non-treated plant.

FIG. 6 shows a wheat plant treated with hydrogel biofertilizer (right) compared with a wheat plant that did not receive the biofertilizer (left). The treated plant was taller, had developed more leaves, and appeared more robust than the non-treated plant.

FIG. 7 shows tomato plants that did not receive the hydrogel biofertilizer (left) and tomato plants that did receive the biofertilizer (right). The treated plants were taller, had developed more leaves, and appeared more robust than the non-treated plant.

FIG. 8 shows tomato plants that did not receive the hydrogel biofertilizer (left) and tomato plants that did receive the biofertilizer (right). The treated plants were taller, had developed more leaves, and appeared more robust than the non-treated plant.

FIG. 9 shows a non-treated tomato plant (left) and a tomato plant that received the hydrogel biofertilizer (right).

FIG. 10A shows violin box plots indicating the differences in wheat height between control plants that received no hydrogel biofertilizer (right) and treated plants that did receive hydrogel biofertilizer (left). Wheat treated with hydrogel biofertilizers demonstrated a significant increase in both plant height and leaf count (t-tests, P<0.05).

FIG. 10B shows violin box plots indicating the differences in wheat leaf count between control plants that received no hydrogel biofertilizer (right) and treated plants that did receive hydrogel biofertilizer (left). Wheat treated with hydrogel biofertilizers demonstrated a significant increase in both plant height and leaf count (t-tests, P<0.05).

FIG. 10C shows violin box plots indicating the differences in tomato height between control plants that received no hydrogel biofertilizer (right) and treated plants that did receive hydrogel biofertilizer (left). Tomato treated with hydrogel biofertilizers demonstrated a significant increase in both plant height and leaf count (t-tests, P<0.05).

FIG. 10D shows violin box plots indicating the differences in tomato leaf count between control plants that received no hydrogel biofertilizer (right) and treated plants that did receive hydrogel biofertilizer (left). Tomato treated with hydrogel biofertilizers demonstrated a significant increase in both plant height and leaf count (t-tests, P<0.05).

FIG. 11A shows hydrogel biotechnology demonstrating fungal growth outside of the hydrogel bead.

FIG. 11B shows hydrogel biotechnology demonstrating observed fungal bacteria interactions of bacterial strains clustering around the fungal hyphae, which can promote access to the plant rhizosphere and increase residency time of bacteria in soil.

FIG. 11C shows hydrogel biotechnology demonstrating a depiction of bacteria traveling out of the hydrogel on the fungal hyphae to mobilize towards areas of the rhizosphere or soil where they can access mineral substrates.

FIG. 12 shows kinetics of PEGDMA encapsulated high biomass of T. aminoaromatica degrading p-cresol.

FIGS. 13A and 13B show images of PEGDMA of T. aminoaromatica under a light microscope (FIG. 13A) and under a CLSM microscope (FIG. 13B).

FIG. 14 shows urea and ammonium removal via hydrogel encapsulated ammonium oxidizing bacteria (N. Lacus) and Anammox (Anammox Brocardia).

### DETAILED DESCRIPTION

One avenue for sustainable agricultural practices that holds potential to reduce use of conventional fertilizers and for remediation of contaminated mediums is the application of beneficial bacteria and fungi to plants and mediums in need (i.e., biofertilizers). Biofertilizers can provide nutrients, profoundly improve plant growth and health, and increase tolerance to abiotic and biotic stresses. Such biofertilizers can be in the form of an inoculant composition. Such inoculant composition can additionally be used for remediation of contaminated mediums.

Provided herein is an inoculant composition comprising a hydrogel bead, a microbial consortia, and a fungi, wherein the microbial consortia and the fungi are in contact with the hydrogel bead.

In some embodiments, the present disclosure comprises a hydrogel construct. Hydrogel constructs can be used to co-entrap microorganisms while providing protection from environmental stressors. Among other features, absorbent hydrogels can hold water and beneficial nutrients, slowly release them, and avoid moisture loss by percolation and evaporation, thus reducing or eliminating nutrient leaching into water systems and permitting a highly functional and drought resilient soil amendment.

A hydrogel construct can comprise a polymer matrix comprising a volume fraction of water, or a large volume fraction of water. In some embodiments, hydrogel constructs comprise cross-linked networks of polymers. In such embodiments, the polymer network can be formed or held together by addition of a cross-linker. Cross-linkers can comprise various chemical compounds including, but not limited to, calcium²⁺, iron²⁺, copper²⁺, barium²⁺, aluminum³⁺, iron³⁺, potassium¹⁺, or other suitable cations for ionotropic gels, or N,N′-methylenebis acrylamide, epoxy compounds, aldehyde compounds, ethylene glycol diacrylates, PEG diacrylates, PEG dithiols, tannic acid, boric acid and substituted boronic acids, for covalently cross-linked gels. Biodegradable gel network-forming materials can comprise alginate, heparin, chitosan, carrageenan, dextran, gelatin, gellan gum, agar, and starch. Non-biodegradable gel materials can comprise PEG acrylates, PEG diacrylates, multi-arm PEG acrylates, multi-arm PEG norbornenes, acrylamides, hydroxy-substituted acrylates, acidic acrylates (e.g. acrylic acids), amine-substituted acrylates (e.g. 2-(diethylamino) ethyl methacrylate), and polyvinyl alcohol.

Hydrogel constructs can exist in a multitude of shapes, forms, and sizes. In some embodiments, the hydrogel construct comprises a bead. The hydrogel construct or bead can be in any shape or size sufficient to contact the microbial consortia, fungi, one or more plant seed, one or more nutrients, water, or a combination thereof.

In some embodiments, the hydrogel is a bead. In some embodiments, the hydrogel bead is comprised of an amount effective to contact the microbial consortia and the fungi. In some embodiments, the hydrogel bead is comprised of an amount effective to contact the microbial consortia, fungi, and water. In some embodiments, the hydrogel bead is comprised of an amount effective to contact the microbial consortia, fungi, and one or more nutrients. In some embodiments, the hydrogel bead is comprised of an amount effective to contact the microbial consortia, fungi, water, and one or more nutrients. In some embodiments, the hydrogel bead is comprised of an amount effective to contact the microbial consortia, fungi, and one or more seed. In some embodiments, the hydrogel bead is comprised of an amount effective to contact the microbial consortia, fungi, one or more seed, and water. In some embodiments, the hydrogel bead is comprised of an amount effective to contact the microbial consortia, fungi, one or more seed, and one or more nutrients. In some embodiments, the hydrogel bead is comprised of an amount effective to contact the microbial consortia, fungi, one or more seed, water, and one or more nutrients.

In some embodiments, the inoculant composition comprises one or more nutrients. In some embodiments, the one or more nutrients comprises one or more macro nutrients, one or more micronutrients, one or more co-factors, or a combination thereof. In some embodiments, the one or more macro nutrients comprises chemical compounds such as phosphorus, phosphate, potassium, ammonium, nitrate, nitrogen, or a combination thereof. In some embodiments, the one or more micronutrients comprises iron, magnesium, copper, zinc, or a combination thereof. In some embodiments, the one or more co-factors comprises one or more vitamins. In some embodiments, the one or more nutrients comprises phosphorus, phosphate, potassium, ammonium, nitrate, nitrogen, iron, magnesium, copper, one or more vitamins, or a combination thereof. In some embodiments, the one or more nutrients comprises phosphorus, potassium, nitrogen, iron, magnesium, copper, one or more vitamins, or a combination thereof. A hydrogel construct or hydrogel bead can have a shape approximating or equaling a sphere, hemisphere, ovoid, cylinder, cube, cuboid, or irregular shape comprising one or more divets, one or more protrusions, or a combination thereof.

The hydrogel bead can have a measurement from one surface of the hydrogel to a second surface of the hydrogel, passing approximately through the center of the hydrogel, and which approximates a diameter of the hydrogel bead. The hydrogel bead diameter can be from about 0.2 mm to about 3 cm, from about 0.2 mm to about 2 cm, from about 0.2 mm to about 1 cm, from about 0.5 mm to about 3 cm, from about 0.5 mm to about 2 cm, from about 0.5 mm to about 1 cm, from at least about 0.2 mm, or up to about 3 cm. Hydrogel beads comprising one or more seeds can have a diameter from about 0.5 mm to about 10 cm, from about 0.5 mm to about 9 cm, from about 0.5 mm to about 8 cm, from about 0.5 mm to about 7 cm, from about 0.5 mm to about 6 cm, from about 0.5 mm to about 5 cm, from about 0.5 mm to about 4 cm, from about 1 cm to about 10 cm, from about 1 cm to about 8 cm, from about 1 cm to about 6 cm, from about 1 cm to about 5 cm, from about 1 cm to about 4 cm, from at least about 0.5 mm, or up to about 10 cm.

In some embodiments, the hydrogel bead is biodegradable, wherein the hydrogel bead is capable of degradation by bacteria, fungi, and/or other living organisms of the environment in which the hydrogel bead is placed, or by organisms which are in contact with the hydrogel bead. Such biodegradable hydrogel bead can be fabricated using biodegradable compositions including, but not limited to, cellulose, carrageenan, hyaluronic acid, polysaccharides (e.g. alginate, starch, agarose), chitosan, fibrin, and/or proteins (e.g. gelatin, collagen) or a combination thereof.

In other embodiments, the hydrogel bead is not biodegradable, wherein the hydrogel bead is not capable of degradation by bacteria and other living organisms of the environment in which the hydrogel bead is placed, or by organisms which are in contact with the hydrogel bead. Such non-biodegradable hydrogel beads can have use in applications wherein recovery of the hydrogel is desired.

Recovery of a hydrogel can be desired wherein the hydrogel is considered a contaminant of the medium to which it is applied. For example, a hydrogel can be considered a contaminant when the hydrogel is applied to a plant, any part of a plant, a medium in contact with any part of a plant, a medium to which the hydrogel has been applied, or a medium which could become in contact with any part of a plant. Recovery of a hydrogel can also be desired without any apparent reason.

Recovery of a hydrogel can additionally be desired wherein the microbial consortia and/or fungi in contact with the hydrogel are undesired or are considered a contaminant of a plant, any part of a plant, a medium to which the microbial consortia and/or fungi is applied, a medium which could become in contact with the microbial consortia and/or fungi, or a combination thereof. For example, the microbial consortia and/or fungi can be considered a contaminant when the microbial consortia and/or fungi is applied to a plant, any part of a plant, a medium in contact with any part of a plant, a medium to which the microbial consortia and/or fungi has been applied, and/or a medium which could become in contact with the microbial consortia and/or fungi, for example when the microbial consortia and/or fungi are not native to the plant, the part of the plant, the medium, or a combination thereof.

Recovery of a hydrogel can further be desired wherein the product, by-product, and/or intermediate of a chemical degradation by the inoculant composition is undesired or has an undesired characteristic. For example, recovery of a hydrogel can be desired when the microbial consortia and/or fungi metabolize a chemical to produce an undesirable or harmful chemical, toxin, carcinogen, drug, contaminant, fertilizer, herbicide, fungicide, explosive by-product, petroleum, or radioactive matter.

Recovery of a hydrogel can also be desired when the microbial consortia and/or fungi concentrate a petroleum, explosive, explosive by-product, fertilizer, herbicide, fungicide, pesticide, waste, contaminant, toxin, carcinogen, drug, or radioactive matter, or a degradation product thereof.

Except as otherwise indicated, “plant” is used herein to indicate any part of a plant and any stage of a plant, including, but not limited to, a seed, a plant seedling, a plant stem, a plant trunk, a plant branch, a plant leaf, a plant flower, a plant bulb, a plant fruit, a plant root, any other part of a plant, or a combination thereof. “Plant” is also used to indicate any type of plant (e.g. tree, bush, fern, cactus, algae, moss, flowering plant, conifer, edible, fruit-bearing, crops). In some embodiments, the plants are autotrophic, even upon association with fungi for resources.

Crops comprise crops grown for food production and crops grown for reasons other than food production. Plants or crops to which the inoculant composition is applied can comprise, but is not limited to, Hordeum vulgare L. (barley), Zea mays (corn), Triticum aestivum (wheat), Glycine spp. (e.g. soybeans), Populus spp. (e.g., poplar trees), Panicum spp. (e.g. switchgrass), Solanum spp. (e.g., tomatoes, potatoes), Sorghum spp., Medicago spp. (e.g., alfalfa), Malus spp. (e.g., apples), and/or Lupinus spp. (e.g., lupines).

The medium to which an inoculant composition can be applied includes any medium which is in contact with a plant or any part of a plant, a medium in proximity to a plant wherein the plant or any part of the plant can access the inoculant composition or nutrients from the medium, or a combination thereof. A plant can access the inoculant composition or nutrients from a medium not in contact with a plant upon translocation of the inoculant composition-containing medium, transportation of the inoculant composition through water, air, wind, animal, other natural occurrence, or other unnatural manner. The medium can be a medium in which a plant can grow, live, is found, or can acquire water or nutrients. For example, the medium can comprise soil, compost, dirt, mud, clay, sand, rock, liquid, minerals, peat, coir, impermeable surface, permeable surface, or a combination thereof.

The inoculant composition can be applied to a seed, plant, or part of a plant for the purpose of facilitating plant growth and/or nutrient access and/or uptake in an environment wherein the plant would not otherwise germinate, grow, thrive, or produce fruit. For example, the inoculant composition can facilitate plant growth in nutrient-limited and/or water-stressed conditions such as lava, sand, desert, rock, semi-arid and arid climates; tropical climates; marine environments; areas having high pollution, high salinity, high minerality, charring, or are radiation-exposed; and/or conditions comprising low oxygen and/or a medium lacking any single necessary or preferred nutrient.

The medium to which an inoculant composition can be applied includes any medium independent of the presence of a plant. For example, the medium can comprise soil, compost, dirt, mud, clay, sand, rock, liquid, minerals, peat, coir, impermeable surface, permeable surface, or a combination thereof. Application of the inoculant composition to such a medium includes for the purposes of remediation of the medium.

The inoculant composition comprises a microbial consortia and a fungi. The microbial consortia can comprise bacteria, archaea, or a combination thereof. The inoculant composition microbial consortia comprises one or more microbes. In embodiments wherein there is more than one microbe, the microbes can be the same or can be different. For example, the more than one microbe can comprise one or more bacteria, one or more archaea, or a combination thereof. Further, wherein the microbial consortia comprises one or more bacteria, the microbial consortia can comprise bacteria which are the same or are different. For example, the microbial consortia can comprise one or more of the same genus and species of bacteria; one or more of the same genus, species, and strain of bacteria; one or more of the same genus but different species of bacteria; or one or more different genera of bacteria. Additionally, wherein the microbial consortia comprises one or more archaea, the microbial consortia can comprise archaea which are the same or are different. For example, the microbial consortia can comprise multiple copies of the same genus and species of archaea; can comprise one or more different genera of archaea; can comprise one or more of the same genera but different species of archaea; or can comprise a combination thereof.

In some embodiments, the microbes of the microbial consortia are compatible with each other. In some embodiments, the microbes of the microbial consortia are compatible with the fungi.

In some embodiments, one or more microbes of the microbial consortia are active. In some embodiments, one or more fungi are active. In some embodiments, one or more microbes of the microbial consortia comprise one or more microbes which are inactive. In some embodiments, the fungi comprise one or more fungi which are inactive.

In some embodiments, the microbes of the microbial consortia are wild-type or genetically modified. In some embodiments, the fungi are wild-type or genetically modified.

In some embodiments, the fungi and microbes of the microbial consortia, either individually or in combination, are configured to supply one or more nutrients to a plant, a part of a plant, a medium in contact with a plant, a medium by which a plant can acquire nutrients, or a combination thereof.

In some embodiments, the fungi and microbes of the microbial consortia are configured, individually or in combination, to degrade or remove one or more chemical compounds. For example, the one or more chemical compounds can be a petroleum, explosive, explosive by-product, fertilizer, herbicide, fungicide, pesticide, waste, contaminant, toxin, carcinogen, drug, or radioactive. Such chemical compounds can be present, for example, due to a chemical contamination, spill, leakage, explosion, application, synthetic production, natural production, or a combination thereof.

In some embodiments, the fungi and microbes of the microbial consortia are configured, individually or in combination, to degrade or remove chemical compounds from a medium. Such medium can be a soil, dirt, mud, sand, rock, clay, plant, liquid, minerals, peat, coir, impermeable surface, permeable surface, or a combination thereof.

In some embodiments, the inoculant composition comprises autotrophic microbes, heterotrophic microbes, or a combination thereof. Autotrophic microbes can be prokaryotes, eukaryotes, or a combination thereof, and heterotrophic microbes can be prokaryotes, eukaryotes, or a combination thereof.

In some embodiments, heterotrophic bacteria comprise N-fixing bacteria, P-solubilizing bacteria, denitrification bacteria, or a combination thereof, wherein the N-fixing bacteria, P-solubilizing bacteria, and denitrification bacteria are as described or defined herein.

Heterotrophic N-fixing bacteria can comprise Azospirillum brasilense, Azotobacter vinelandii, Azotobacter chroococcum, Enterobacter spp., Klebsiella spp., Flavobacterium spp. P-solubilizing bacteria can comprise Pseudomonas spp., Enterobacter spp. (e.g. Enterobacter ludiwgii), Bacillus spp. (e.g. Bacillus megaterium), or a combination thereof.

Heterotrophic P-solubilizing Pseudomonas spp. can comprise Pseudomonas putida, Pseudomonas rhizosphaerae, Pseudomonas aeruginosa, another Pseudomonas spp. which is known to exhibit, or exhibits, P solubilization and/or other plant growth promoting effects, or a combination thereof.

Heterotrophic denitrification bacteria can comprise Pseudomonas spp., Alcaligenes spp., Bacillus spp., Flavobacterium spp., or a combination thereof.

In some embodiments, autotrophic bacteria comprise ammonium oxidizing bacteria, complete ammonia oxidizing bacteria, nitrite oxidizing bacteria, or a combination thereof, wherein ammonium oxidizing bacteria, complete ammonia oxidizing bacteria, and nitrite oxidizing bacteria, are as described herein.

Autotrophic ammonium oxidizing bacteria can comprise Nitrosomonas spp., Nitrosococcus spp., Nitrospira spp., or a combination thereof.

Autotrophic complete ammonia oxidizing bacteria can comprise Nitrospira spp. (e.g. Nitrospira inopinata).

Autotrophic nitrite oxidizing bacteria can comprise Nitrobacter spp., Nitrospina spp., Nitrospira spp., Nitrococcus spp., Nitrotoga spp., Nitrolancaea spp., or a combination thereof.

In some embodiments, autotrophic archaea comprise ammonium oxidizers, wherein ammonium oxidizers are as described herein.

Ammonium oxidizers can comprise Nitrosopumilus spp., Nitrososphaera spp., Nitrobacter spp., or a combination thereof.

In some embodiments, the microbial consortia comprises prokaryotic microbes, eukaryotic microbes, or a combination thereof.

In some embodiments, the microbial consortia comprises anaerobic bacteria, aerobic bacteria, anaerobic archaea, aerobic archaea, or a combination thereof.

Ammonia and ammonium as used herein are interchangeable.

In some embodiments, the microbial consortia comprises ammonia oxidizing bacteria and/or ammonium oxidizing bacteria. Ammonia and/or ammonium oxidizing bacteria can comprise Nitrosomonas spp., Nitrosococcus spp., Nitrospira spp., or a combination thereof. In some embodiments, the microbial consortia can comprise the anaerobic ammonium oxidizing bacteria Anammox (Anammox brocardia).

In some embodiments, the microbial consortia comprises ammonia and/or ammonium oxidizing archaea. Ammonia and/or ammonium oxidizing archaea can comprise Nitrosopumilus spp., Nitrososphaera spp., or a combination thereof.

In some embodiments, the microbial consortia comprises complete ammonium oxidizers. Complete ammonium oxidizers can comprise Nitrospira inopinata.

In some embodiments, the microbial consortia comprises nitrite oxidizing bacteria. Nitrite oxidizing bacteria can comprise Nitrobacter spp., Nitrospina spp., Nitrospira spp., Nitrococcus spp., Nitrotoga spp., Nitrolancaea spp., or a combination thereof.

In some embodiments, the microbial consortia comprises ammonium and/or nitrite-oxidizing bacteria, ammonium-oxidizing archaea, or a combination thereof. Ammonium oxidizing bacteria can compromise Nitrosomonas spp., Nitrosococcus spp., Nitrosospria, Nitrosolobus spp., Nitrosovibrio spp., or a combination thereof. Ammonium oxidizing archaea can comprise Nitrososphaera spp., Nitrosocosmicus spp., Nitrosopumilus spp., or a combination thereof.

In some embodiments, the microbial consortia comprises urease active microbes. Urease active microbes can release ammonia from sources including fertilizer. In some embodiments, the microbial consortia comprises urease active microbial consortia that convert urea naturally occurring in mediums (e.g. soils) to one or more chemical compounds capable of uptake by a plant. In some embodiments, the microbial consortia comprises urease active microbial consortia that convert urea artificially present in mediums (e.g. soils) to a chemical compound capable of uptake by a plant. In some embodiments, the microbial consortia comprises urea hydrolyzing bacteria. Urease active bacteria can comprise Proteus spp., Nocardia spp., Ureaplasma spp., Helicobacter pylori, Klebsiella spp., Staphylococcus epidermidis, Staphylococcus saprophyticus, or a combination thereof.

In some embodiments, the microbial consortia comprises nitrogen fixing bacteria that fix N₂ into a chemical compound accessible to a plant and/or capable of uptake by a plant. In some embodiments, the microbial consortia comprises nitrogen fixing archaea that fix N₂ into a chemical compound accessible to a plant and/or capable of uptake by a plant. N₂ can arise from any source, including, but not limited to, from the atmosphere, plants and algae, N₂ which is applied, and N₂ which is produced by a chemical process.

In some embodiments, the microbial consortia comprises Azotobacter spp., Azospirillum spp., Bacillus spp., Pseudomonas spp., Enterobacter spp., or a combination thereof.

In some embodiments, the microbial consortia comprises denitrifying bacteria. Denitrifying bacteria can comprise Pseudomonas spp., Ralstonia spp., Alcaligenes spp., Paracoccus spp., Rhodobacter spp., Rubrivivax spp., Thauera spp., Burkholderia spp., Bacillus spp., and Streptomyces spp.

In some embodiments, the microbial consortia comprises phosphate solubilizing bacteria. Phosphate solubilizing bacteria convert phosphorus from a medium (e.g. soils) into a form capable of plant uptake. In some embodiments, the microbial consortia comprises Pseudomonas spp., Enterobacter spp., Burkholderia spp., Bacillus spp., or a combination thereof.

In some embodiments, the microbial consortia comprises microbes capable of chemical degradation, such as degradation of one or more chemical compounds, petroleum, explosive, explosive by-product, fertilizer, herbicide, pesticide, fungicide, waste, contaminant, toxin, carcinogen, drug, radioactive compound, or a combination thereof. Such microbes are capable of chemical degradation of chemicals arising from contamination, spill, leakage, explosion, application, synthetic production, natural production, or a combination thereof. In some embodiments, the microbial consortia comprises Desulfobacula phenolica, Goebacter, Thauera aminoaromatica bacteria, or a combination thereof.

In some embodiments, the microbial consortia comprises plant growth promoting bacteria. Plant growth promoting bacteria comprise Azospirillum spp., Pseudomonas spp., Bacillus spp., Paenibacillus spp. Burkholderia spp., Klebsiella spp., Serratia spp. Enterobacter spp. Flavobacterium spp., and Acinetobacter spp.

In some embodiments, the microbial consortia comprises N-fixing bacteria, P-solubilizing bacteria, nitrifying bacteria, urease active bacteria, archaea, or a combination thereof. In some embodiments, the microbial consortia comprises one or more N-fixing bacteria, one or more P-solubilizing bacteria, one or more nitrifying bacteria, one or more urease active bacteria, one or more archaea, or a combination thereof.

In an embodiment, the inoculant composition comprises fungi.

An inoculant composition comprising fungi can increase nutrient uptake and/or crop yield. An inoculant composition comprising fungi can degrade one or more chemical compounds. In some embodiments, the fungi is capable of chemical degradation, such as degradation of one or more chemical compounds, a petroleum, explosive, explosive by-product, fertilizer, herbicide, pesticide, fungicide, waste, contaminant, toxin, carcinogen, drug, radioactive compound, or a combination thereof.

In some embodiments, the fungi are capable of chemical degradation of one or more chemicals arising from contamination, spill, leakage, explosion, application, synthetic production, natural production, or a combination thereof.

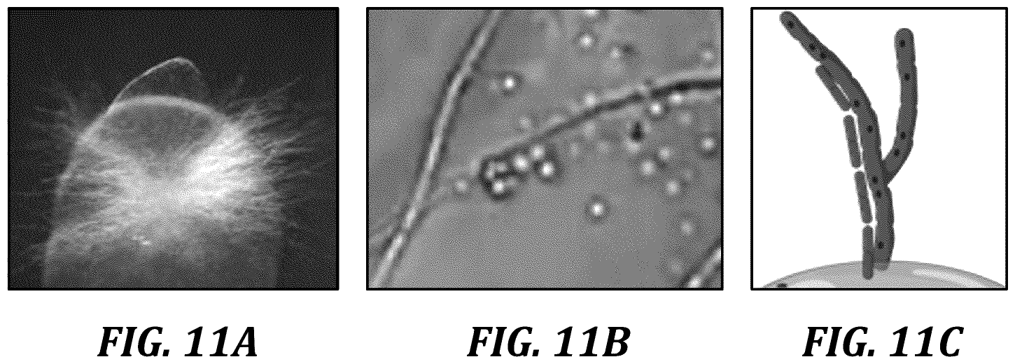

Fungi, such as arbuscular mycorrhizal fungi (AMF), are obligate mutualists, or symbiont fungi, that associate with plant roots, forming arbuscules and/or vesicles, and expand the surface area by attaching to and expanding out from, the plant rooting system. This allocates available nutrients to the plant root through the fungal network, increasing the plant's ability to efficiently access and absorb soil nitrogen (N), phosphorus (P), and/or water, hence reducing N and P losses to surrounding environments, and reducing ground water pollution. FIG. 11A shows hydrogel biotechnology demonstrating fungal growth outside of the hydrogel bead. Fungi can increase nutrient uptake, plant growth, and both abiotic and biotic stress tolerance in crops. Fungi can additionally host a diversity of endobacteria (bacteria living in tissues) which promote nutritional interactions that can result in increased N-fixation and plant NUE. FIG. 11B shows the hydrogel biotechnology demonstrating observed fungal bacteria interactions of bacterial strains clustering around the fungal hyphae, which can promote access to the plant rhizosphere and increase residency time of bacteria in soil. Hydrogel biotechnology wherein bacteria travel out of the hydrogel on the fungal hyphae to mobilize towards areas of the rhizosphere or soil where they can access mineral substrates is shown in FIG. 11C.

In some embodiments, the fungi are heterotrophic and comprise arbuscular mycorrhizal fungi (AMF), ectomycorrhizal fungi, ericoidal mycorrhizal fungi, plant growth promoting fungi, decomposer fungi, fungi which degrade one or more chemical compounds, or a combination thereof.

In some embodiments, AMF comprises Acaulospora spp., Funneliformis spp., Rhizophagus spp., Glomus spp., Claroideoglomus spp., Gigaspora spp., Scutellospora spp., Diversispora spp. or a combination thereof. In some embodiments, Acaulospora spp. comprises Acaulospora betriticulata, Acaulospora trappei, Acaulospora morrowiae, Acaulospora delicata, Acaulospora laevis, or a combination thereof. In some embodiments, Funneliformis spp. comprises Funneliformis mosseae, Funneliformis caledonium, or a combination thereof. In some embodiments, Rhizophagus spp. comprises Rhizophagus intraradices, Rhizophagus clarus, Rhizophagus irregularis, Rhizophagus fasciculatus, or a combination thereof. In some embodiments Glomus spp. comprises Glomus macrocarpum, Glomus microcarpum, Glomus aggregatum, Glomus microaggregatum, Glomus clarum, or a combination thereof. In some embodiments, Claroideoglomus spp. comprises Claroideoglomus candidum, Claroideoglomus etunicatum, Claroideoglomus claroideum, Claroideoglomus lamellosum, or a combination thereof. In some embodiments, Gigaspora spp. comprises Gigaspora albida, Gigaspora gigantea, Gigaspora rosea, Gigaspora margarita, or a combination thereof. In some embodiments, Scutellospora spp. comprises Scutellospora reticulata, Scuttelospora pellucida, Scuttelospora heterogama, or a combination thereof. In some embodiments, Diversispora spp. comprises Diversispora aurantia, Diversispora celata, Diversispora epigaea, Diversispora versiformis, or a combination thereof. In some embodiments, AMF comprises Rhizophagus irregularis (strains: CR316A-21, DN201-15, ON205B-12, and/or PL112A-7), Rhizophagus intraradices (AZ243-24, C0204-21, UT126A-39, and/or WV116-24), Funneliformis mosseae (BR232D-25, NC302C-10, UK118-18, and/or WV902A-17), or a combination thereof.

In some embodiments, ectomycorrhizal fungi comprise Amanita spp., Hebeloma spp., Hysterangium spp., Laccaria spp., Lactarius spp., Rhizopogon spp., Russuia spp., Scleroderma spp., Suillus spp., Tricholoma spp., Cantharellus spp., Tuber spp., or a combination thereof.

In some embodiments, ericoidal mycorrhizal fungi comprise Meliniomyces spp. Hymenoscyphus spp., Oidiodendron spp., or a combination thereof.

In some embodiments, plant growth promoting fungi comprise Trichoderma spp., Penicillium spp., Fusarium spp., Phoma spp., Aspergillus spp., Mortierella spp., or a combination thereof Trichoderma spp. can comprise Trichoderma harzianum, Trochoderma viride, Trichoderma virens, or a combination thereof Aspergillus spp. can comprise Aspergillus niger, Aspergillus terreus, or a combination thereof Mortierella spp. can comprise Mortierella elongata.

In some embodiments, decomposer fungi comprise Hormoconis resinae, Aspergillus spp., Mortierella spp., Trametes spp., Pleurotus spp., Trichoderma spp., or a combination thereof.

In some embodiments, fungi which degrade one or more chemical compounds comprise Hormoconis resinae, Aspergillus spp., Mortierella spp., Trametes spp., Pleurotus spp., Trichoderma spp., Metarhizium spp., Penicillium spp., or a combination thereof.

In some embodiments, the microbial consortia and the fungi are encapsulated within the hydrogel bead or hydrogel film. Within the hydrogel bead or hydrogel film, the microbial consortia can be in contact with the fungi, or the microbial consortia can be isolated from the fungi. In some embodiments, the microbial consortia and/or the fungi are in contact with one or more nutrients, water, one or more seed, or a combination thereof. In some embodiments, the microbial consortia and/or the fungi are isolated from one or more nutrients, water, one or more seed, or a combination thereof.

In some embodiments, the microbial consortia is comprised of an amount effective to release one or more nutrient to a plant; and the fungi is comprised of an amount effective to associate with a plant root and increase plant access to, or uptake of, the one or more nutrient. The effective amount of microbial consortia and fungi can arise from the amount of microbial consortia, the amount of fungi, a combination of the amount of microbial consortia and the amount of fungi, or a synergistic effect arising from the combination of the amount of microbial consortia and the amount of fungi.

In other embodiments, the microbial consortia is comprised of an amount effective to degrade one or more chemical compounds; and the fungi is comprised of an amount effective to degrade one or more chemical compounds. The degradation of one or more chemical compounds can arise from the amount of microbial consortia, the amount of fungi, a combination of the amount of microbial consortia and the amount of fungi, or a synergistic effect arising from the combination of the amount of microbial consortia and the amount of fungi.

In some embodiments, the one or more nutrient released to a plant is released at a rate approximating the rate of uptake by the plant. In some embodiments, the one or more nutrient made accessible to a plant is made accessible at a rate approximating the rate of uptake by the plant.

In other embodiments, the rate of degradation of one or more chemical compounds approximates the rate of chemical compound production, the rate of degradation of one or more chemical compounds is less than the rate of chemical compound production, the rate of degradation of one or more chemical compounds exceeds the rate of chemical compound production.

In some embodiments, the inoculant composition comprises an excipient suitable for applying the inoculant composition. In some embodiments, a suitable excipient comprises water, alginate, levodopa, 1-3,4-dihydroxyphenylalanine, polyvinyl alcohol, or a combination thereof. In some embodiments, a suitable excipient comprises acrylate derivatives of polyethylene glycol (PEG). Acrylate derivatives of PEG can comprise diacrylate, PEG dimethacrylate, or a combination thereof. In some embodiments, a suitable excipient comprises lysine, lysine derivatives, poly-L-lysine, or a combination thereof.

In some embodiments, the inoculant composition comprises a seed. In some embodiments, the inoculant composition comprises a seed wherein the seed has a diameter of less than about 3 cm, of between about 0.05 mm and about 3 cm, of between about 0.05 mm and about 2 cm, of between about 0.05 mm and about 1 cm, of between about 0.05 mm and about 0.5 cm, of between about 0.2 mm and about 3 cm, of between about 0.2 mm and about 2 cm, of between about 0.2 mm and about 1 cm, of between about 1 mm and about 5 mm, or of between about 0.5 cm and about 3 cm.

In some embodiments, the inoculant composition comprises one seed. In some embodiments, the inoculant composition comprises more than one seed.

In some embodiments, the seed comprises a seed from, but not limited to, the plants comprising, Hordeum vulgare L. (barley), Zea mays (corn), Triticum aestivum (wheat), Glycine spp. (e.g. soybeans), Populus spp. (e.g., poplar trees), Panicum spp. (e.g. switchgrass), Solanum spp. (e.g., tomatoes, potatoes), Sorghum spp., Medicago spp. (e.g., alfalfa), Malus spp. (e.g., apples), and/or Lupinus spp. (e.g., lupines).

In some embodiments, the seed is encapsulated. In some embodiments, the seed is encapsulated by the hydrogel.

The present disclosure comprises a method of increasing nutrient acquisition in a plant in need thereof, the method comprising: first, generating an inoculant composition for a treatment of a plant, a part of a plant, a medium in contact with a plant, or a combination thereof, wherein the inoculant composition comprises an effective amount of a hydrogel bead, an effective amount of a microbial consortia, and an effective amount of a fungi, and wherein the microbial consortia and the fungi are in contact with the hydrogel bead; and second, applying the inoculant composition to the plant, part of the plant, medium in contact with the plant, or a combination thereof, or a medium in proximity to a plant wherein the plant can access the inoculant composition from the medium.

The method comprises the inoculant composition as heretofore and hereinafter described. The method comprises generating the inoculant composition as heretofore and hereinafter described.

In some embodiments, the generating the inoculant composition comprises placing the inoculant composition into an excipient effective for the applying the inoculant composition. The excipient is as heretofore and hereinafter described.

The amount of hydrogel, microbial consortia, and fungi are as heretofore and hereinafter described. The amount of hydrogel, microbial consortia, and fungi comprise an amount which increases plant access and uptake of nutrients relative to the amount of access and uptake which would occur in the absence of applying the inoculant composition.

In some embodiments, the method comprises applying the inoculant composition to a plant, part of a plant, medium in contact with a plant, or a combination thereof, or a medium in proximity to a plant, wherein the plant can access the inoculant composition from the medium.

In some embodiments, the method comprises applying the inoculant composition directly to a plant, a part of a plant, or medium in contact with a plant, or indirectly to a plant, part of a plant, or medium in contact with a plant.

In other embodiments, the applying the inoculant composition comprises applying the inoculant composition to a medium, as heretofore and hereinafter described, in proximity to a plant which is not directly accessible by a plant, but by which the plant can access the inoculant composition by translocation or movement of the medium. In some embodiments, the plant can access the inoculant composition as a result of intentional or unintentional, natural or unnatural, movement of the medium comprising the inoculant composition (e.g. movement of soil comprising the inoculant composition).

In some embodiments, the plant can access the inoculant composition as a result of intentional or unintentional, natural or unnatural, movement of the inoculant composition. For example, the plant can access the inoculant composition as a result of the flow of water causing translocation of the inoculant composition from its application location to the plant location. In another example, the plant can access the inoculant composition as a result of translocation of the inoculant composition from its application location to the plant location by gas flow such as by wind. In a further example, the plant can access the inoculant composition as a result of translocation of the inoculant composition from its application location to the plant location caused by animal movement.

In some embodiments, the applying the inoculant composition comprises disseminating the inoculant composition by a method suitable for disseminating one or more hydrogel bead, or a method suitable for disseminating an excipient comprising one or more hydrogel bead. Such method can comprise spraying, dropping, tossing, blowing, and the like. Such method can comprise applying by a machine, equipment, airplane, motor vehicle, human, or a combination thereof.

The present disclosure comprises a method of degrading one or more chemical compounds from a medium comprising a chemical compound contaminant, the method comprising: first, generating an inoculant composition for a treatment of a medium in need thereof, wherein the inoculant composition comprises an effective amount of a hydrogel bead, an effective amount of a microbial consortia, and an effective amount of a fungi, wherein the microbial consortia and the fungi are in contact with the hydrogel bead; and second, applying the inoculant composition to the medium in need thereof, wherein the inoculant composition contacts the medium.

The method comprises the inoculant composition as heretofore and hereinafter described. The method comprises generating the inoculant composition as heretofore and hereinafter described.

The generating the inoculant composition further comprises placing the inoculant composition into an excipient effective for the applying the inoculant composition. The excipient is as heretofore and hereinafter described.

In some embodiments, the method comprises degrading one or more chemical compounds which is considered a petroleum, explosive, explosive by-product, fertilizer, herbicide, fungicide, pesticide, waste, contaminant, toxin, carcinogen, drug, or is radioactive.

In some embodiments, the method comprises applying the inoculant composition to a medium in need thereof. Such a medium can comprise a soil, dirt, mud, sand, rock, clay, plant, liquid, minerals, peat, coir, impermeable surface, permeable surface, or a combination thereof.

The amount of hydrogel, microbial consortia, and fungi are as heretofore and hereinafter described.

The method comprises an amount of hydrogel effective to contact the microbial consortia and the fungi, and the amount of microbial consortia and the amount of fungi is an amount effective to degrade a chemical compound contaminant individually or as a combination of the microbial consortia and fungi.

The amount of microbial consortia and fungi comprise an amount which results in the decrease of one or more chemical compound in the medium relative to the amount of that chemical compound in the medium which would exist in the absence of applying the inoculant composition. Alternately, the amount of microbial consortia and fungi comprise an amount which results in the increase of one or more chemical compound, which is a product, by-product, intermediate, or metabolite, in the medium relative to the amount of that product, by-product, intermediate, or metabolite chemical compound in the medium which would exist in the absence of applying the inoculant composition.

Specific elements of any embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

Unless otherwise indicated, all numbers expressing quantities of components in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed in light of the number of reported significant digits and by applying ordinary rounding techniques.

The complete disclosure of all patents, patent applications, and publications cited are herein incorporated by reference in their entirety. Supplementary materials referenced in publications (such as supplementary tables, supplementary figures, supplementary materials and methods, and/or supplementary experimental data) are likewise incorporated by reference in their entirety. In the event any inconsistency exists between the disclosure of the present application and the disclosure(s) of any document incorporated herein by reference, the disclosure of the present application shall govern.

The foregoing detailed description and examples have been given for clarity of understanding only. No unnecessary limitations are to be understood therefrom. The disclosure is not limited to the exact details shown and described, for variations obvious to one skilled in the art will be included within the disclosure defined by the claims.

### EXAMPLES

This disclosure describes the inoculant composition preparation and the demonstrated activity of a hydrogel bead comprising microbial consortia and fungi, for use in inoculating plants or mediums to provide nutrients to plants without the need for excess chemical fertilizers, for methods to synergistically increase nutrient acquisition in plants, as well as for use in medium remediation.

Organisms described herein, including specimens, spores, propagules, and/or cultures, are known and readily available, and can be obtained from the International Culture Collection of Vesicular Arbuscular Mycorrhiza, International Bank of Glomeromycota, Glomeromycota In Vitro Collection, International Culture Collection of Glomeromycota, American Type Culture Collection, German Collection of Microorganisms and Cell Cultures, or from scientists/groups that have published or deposited the organism into a known depository. Once obtained, the foregoing can be maintained using conditions known to a person having ordinary skill in the art.

Organisms comprising gene knockouts can be generated by procedures known to a person having ordinary skill in the art. Such genetically modified organisms are known and readily available to the public through publication, and are widespread among those having ordinary skill in the art.

### Example 1

AMF Germination within a Hydrogel Bead in the Presence of N-fixing Bacteria

In developing a mixed consortium hydrogel biofertilizer that may increase crop growth, whether certain species and within-species strains of AMF can germinate in the presence of diazotrophic PGPB following co-entrapment was tested. The germination rate of three AMF species (four strains per species) when co-entrapped with Azospirillum brasilenses Sp7, a bacterium that is being increasingly used in biofertilizers due to its abilities to produce plant growth regulators and fix atmospheric N, was tested.

Twelve inoculants of AMF were provided by the International Culture Collection of Vesicular Arbuscular Mycorrhiza. The species included Rhizophagus irregularis (strains: CR316A-21, DN201-15, ON205B-12, and PL112A-7), Rhizophagus intraradices (AZ243-24, CO204-21, UT126A-39, and WV116-24), and Funneliformis mosseae (BR232D-25, NC302C-10, UK118-18, and WV902A-17). A total of 800 spores were isolated from each inoculum, surface sterilized, and stored until co-entrapment. A culture of A. brasilense Sp7 (DSM 1690) was obtained from the German Collection of Microorganisms and Cell Cultures (DSMZ) and was maintained in DSMZ 221 media lacking N sources. Methods on AMF spore isolation, bacterium culture maintenance, and hydrogel co-entrapment are as described in the subsequent examples.

Once co-entrapped, 100 hydrogel beads per consortium identified in Table 1, with at least 2 AMF spores, were selected. This produced a total of 1,200 beads to determine the percentage of potentially infective beads (% PIB). This method originated to determine the percent of beads with at least one germinated AMF spore, and has been adapted by others. To evaluate % PIB, sterilized MSR media lacking sucrose and vitamins was distributed into Petri plates and 100 beads per consortium were evenly distributed into 10 plates, respectively, and embedded in the media before solidification. For each consortium, 20 blank beads were also fabricated and evenly distributed into two plates to rule out any potential contamination during the bead forming process.

The plates were incubated in a temperature controlled dark room at 28° C. On days 2, 3, 4, 6, 9, and 14 plates were checked for germinated AMF spores and A. brasilense Sp7 colonies using a stereomicroscope. Beads were marked as PIB if at least one germinated AMF spore was observed. To calculate % PIB for each AMF strain, the number of PIB on each day of observation was divided by the number of replicates. To determine if A. brasilense Sp7 successfully formed colonies while co-immobilized with the 12 different AMF strains, the beads were observed for visible bacterial growth. If at least one A. brasilense Sp7 colony was observed during the incubation, the bead was marked for successful bacterial growth. Statistical tests executed on this dataset are described in the examples which follow.

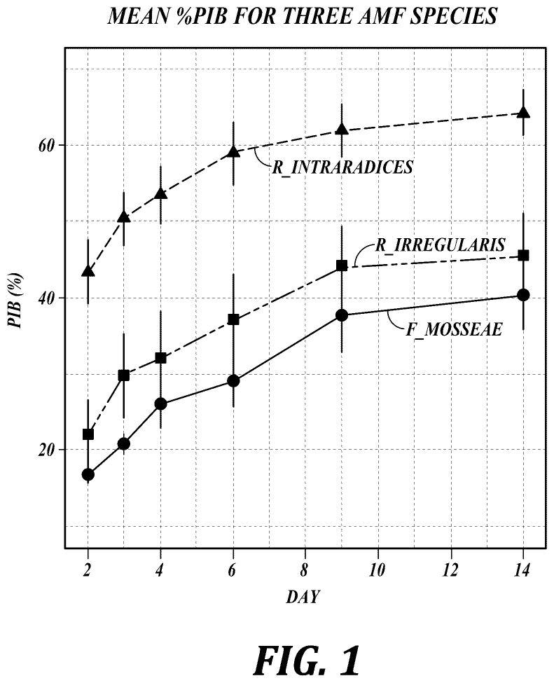

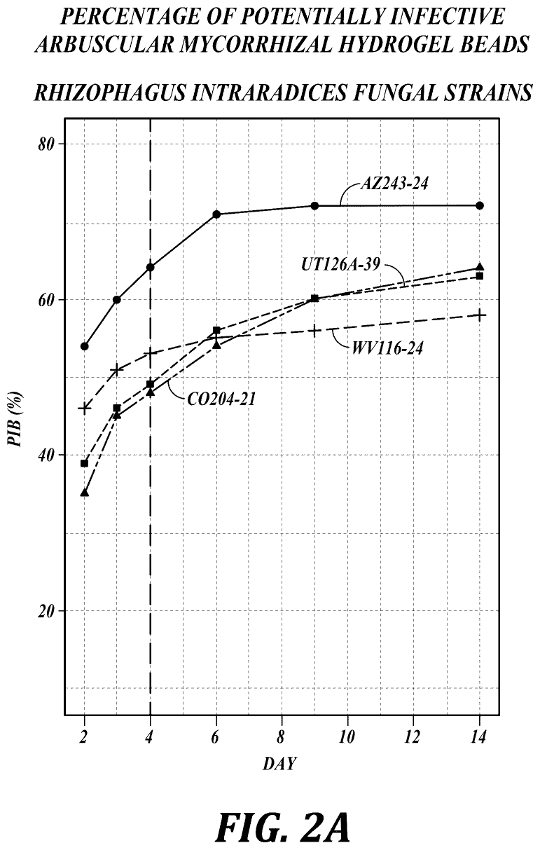

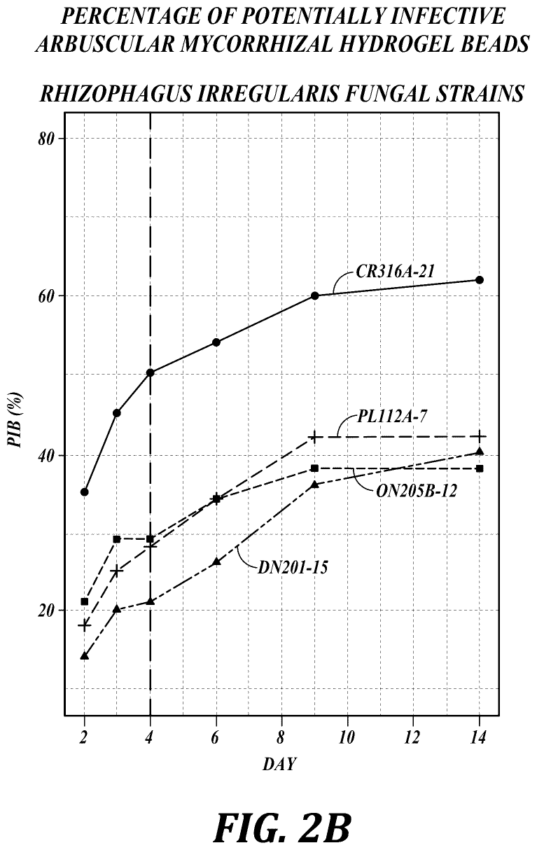

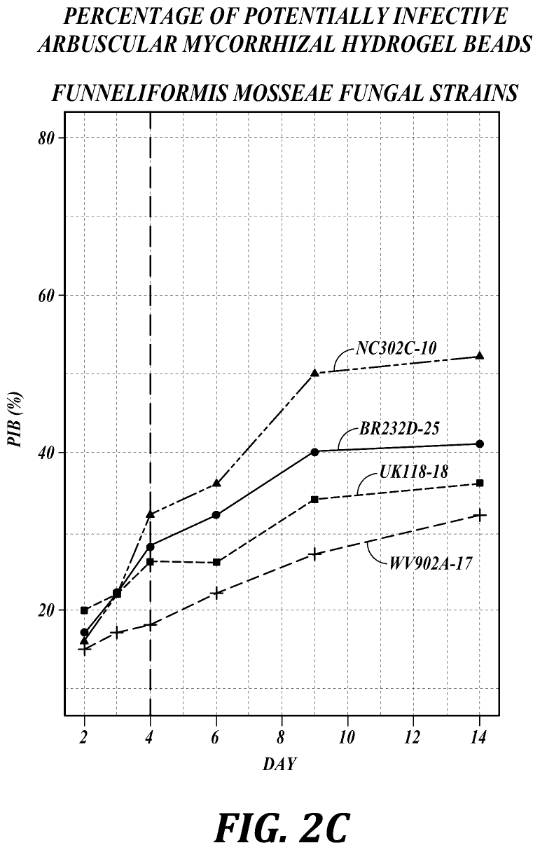

The mean % PIB at the species level was calculated (i.e., species-level strains were not analyzed individually), and found that spore germination rates varied across the three AMF species when co-entrapped with A. brasilense Sp7, shown in FIG. 1. The % PIB among the three AMF species on day 14 significantly differed (F=8.22, P<0.05) with R. intraradices having the highest % PIB (64.3% ±2.8), followed by R. irregularis (45.5% ±5.6), and F. mosseae (40.3% ±4.3). Specifically, % PIB was different between R. irregularis and F. mosseae (P<0.05) and R. irregularis and R. intraradices (P<0.05), but not between R. irregularis and F. mosseae. When exploring % PIB across AMF species strains, there were no differences in % PIB among R. intraradices strains (X²=4.88, P=0.18, FIG. 2A). Differences were observed in the germination success of both R. irregularis strains (X²=16.32, P<0.05, FIG. 2B) and F. mosseae strains (X²=9.35, P<0.05, FIG. 2C). On day 4, 100% of the beads across the 12 consortia demonstrated bacterial growth, and on day 14 it was confirmed that A. brasilense Sp7 colonies were present in all the beads with successful AMF spore germination. No bacterial growth was observed in the blank beads.

Studies have explored the entrapment of various strains of A. brasilense in alginate beads, as well as germination success of several AMF species. However, the potential compatibility of A. brasilense Sp7 with various species of AMF in the hydrogel construct, and spore germination success across AMF strains, is unknown. This study shows that the diazotrophic PGPB A. brasilense Sp7 grew in the presence of all AMF strains, as shown in FIGS. 2A-2C, and that spore germination rates varied. This suggests that the selection of AMF is a step in the formulation of a mixed consortium hydrogel biofertilizer, as AMF can be sensitive to the presence of other microorganisms. For example, certain bacteria inhibit germination or plant establishment of AMF, while others promote it. Additionally, AMF spore germination can also depend on factors like soil pH and nutrient availability, so further studies are needed to address the versatility and applicability.

Nonetheless, fundamental information on the compatibility of 12 AMF strains and A. brasilenses Sp7 when co-entrapped in hydrogel beads is provided, with the goal of contributing to the progress and development of sustainable biofertilizers that may amend conventional fertilizer use by increasing plant N uptake and growth. Although spore germination rates were different among the three AMF species and their strains, co-entrapment with A. brasilense Sp7 did not completely hinder spore germination in any of the AMF. This suggests that all 12 hydrogel consortia hold potential to be applied as a biofertilizer that may promote sustainable agricultural practices.

TABLE 1
Twelve arbuscular mycorrhizal fungi co-entrapped in
hydrogel beads with Azospirillium brasilense Sp7.

| Fungal-bacterial combination | Acronym |
|---|---|
| Rhizophagus irrelgularis CR316A-21 + | R. irregularis1 + |
| Azospirillium Brasilense Sp7 | Nfixer |
| Rhizophagus irrelgularis DN102-15 + | R. irregularis2 + |
| Azospirillium Brasilense Sp7 | Nfixer |
| Rhizophagus irrelgularis ON205B-12 + | |
| Azospirillium Brasilense Sp7 | |
| Rhizophagus irrelgularis PL112A-7 + | |
| Azospirillium Brasilense Sp7 | |
| Rhizophagus intraradices AZ243-24 + | |
| Azospirillium Brasilense Sp7 | |
| Rhizophagus intraradices CO204-21 + | |
| Azospirillium Brasilense Sp7 | |
| Rhizophagus intraradices UT126A-39 + | |
| Azospirillium Brasilense Sp7 | |
| Rhizophagus intraradices WV116-24 + | |
| Azospirillium Brasilense Sp7 | |
| Funneliformis mosseae BR232D-25 + | |
| Azospirillium Brasilense Sp7 | |
| Funneliformis mosseae NC302C-10 + | |
| Azospirillium Brasilense Sp7 | |
| Funneliformis mosseae UK118-18 + | |
| Azospirillium Brasilense Sp7 | |
| Funneliformis mosseae WV902A-17 + | |
| Azospirillium Brasilense Sp7 | |

### Example 2

### Spore Separation, Bacterial Maintenance, and Hydrogel Fabrication

A wet sieving and centrifugation method (Brundrett et al 1996) was used to collect spores from the 12 arbuscular mycorrhizal fungal (AMF) inoculants. Species-specific fungal strains were kept separate. After spores were separated and rinsed in MilliQ H₂O, material was transferred to a sterile Petri plate. Each petri plate containing spores was placed under a Leica dissecting scope and 800 spores were collected for each strain, the spores were surfaced sterilized by a 2% bleach soak for 1 min, a MilliQ H₂O rinse for 5 min, a 70% ethanol soak for 2 min, a MilliQ H₂O rinse for 2 min, and then an antibiotic solution soak containing 0.5% streptomycin, 0.2% chloramphenicol, and a few drops of Tween 80 for 15 min. Following surface sterilization, spores were rinsed in MilliQ H₂O and transferred to sterile petri plates and stored at 4° C. until hydrogel encapsulation.

On the day of hydrogel co-entrapment, A. brasilense Sp7 cells were diluted to an OD₆₀₀ of 0.125, which corresponds to roughly 10⁷ CFU/ml. Spores belonging to each isolate of AMF were kept separate, transferred to sterile beakers, and each isolate was resuspended in 5 ml of sterilized (121° C. for 30 min) 4% sodium-alginate solution (w/v). Subsequently, 5 ml of A. brasilenses Sp7 cells suspended in the N-free liquid media (OD₆₀₀=0.125) was added to each beaker bringing the volume to 10 ml and in return diluting the solution to 2% sodium-alginate (w/v).

To form hydrogel beads, a peristaltic pump was set up. Each beaker of AMF/bacteria consortia was placed on a magnetic plate stirrer for continuous suspension of spores and cells. Subsequently, one end of sterile tubing connected to the pump was inserted into a beaker containing the AMF/bacteria and the opposite end of the tubing was connected to a 24-gauge dispensing tip that dispensed ˜30 μl per drop. Prior to turning on the pump, the dispensing tip was situated over a 250 ml beaker on a magnetic plate stirrer containing 175 ml of sterilized 0.1M CaCl₂). Once the pump was turned on, alginate beads were formed by polymerization when a droplet entered the CaCl₂) solution. At the end of this step, there were 12 varieties of hydrogel beads consisting of the different AMF and A. brasilenses Sp7 (Table 1).

### Statistical Analysis

To determine if there were any significant differences among the percentage of potentially infective beads (% PIB) co-entrapped with diazotrophic plant-growth promoting A. brasilense Sp7 at the end of the incubation period, a one-way analysis of variance (ANOVA) test was implemented on day 14% PIB for each AMF species (R. irregularis, R. intraradices, and F. mosseae). Species were not separated by species-specific strains for this test, as the purpose was general germination success among the three AMF species, regardless of strain. It was confirmed that the data fit model assumptions (normally distributed and homogeneity of variances) by executing a Levene's test and Shapiro-Wilk's normality test on model residuals. Subsequently, a Tukey's posthoc test was implemented for pairwise comparisons between the % PIB-AMF of the three species.

To test if there were any significant differences among the amount of PIB for each isolate (i.e., within species PIB), day 14 “Yes/No” frequency counts of PIB were subsetted into R. irregularis, R. intraradices, and F. mosseae datasets. A Pearson's chi-squared test was run on each subset of data. Colony formation of A. brasilenses Sp7 was observed and noted, the percent of beads that had successful bacterial growth while co-entrapped with germinated spores was determined by dividing the beads that had visible colonies by the total replicates per consortium. All analyses were executed using R software and all plots were generated using the ggplot2 package (Wickham).

The average percentage of potentially infective beads (% PIB) for the three arbuscular mycorrhizal fungal (AMF) species (Rhizophagus intraradices, R. irregularis, and Funneliformis mosseae), averaged across the four AMF species-specific strains, is shown in FIG. 1. As seen in FIG. 1, on day 14, the % PIB significantly differed across the three AMF species (F=8.22, P<0.05), with R. intraradices demonstrating the highest % PIB (64.3% ±2.8), followed by R. irregularis (45.5% ±5.6) and F. mosseae (40.3% ±4.3).

The average percentage of potentially infective beads (% PIB) for the four species-specific strains of Rhizophagus intraradices, Rhizophagus irregularis, and Funneliformis mosseae is shown in FIGS. 2A-2C. At the end of the incubation (day 14), no differences were observed in % PIB among R. intraradices strains (X²=4.88, P=0.18), but germination success was different among species-specific strains of R. irregularis (X²=16.32, P<0.05) and F. mosseae (X²=9.35, P<0.05). The vertical grey dashed line on day 4 denotes the time point that all PIB had visible colonies of A. brasilenses Sp7.

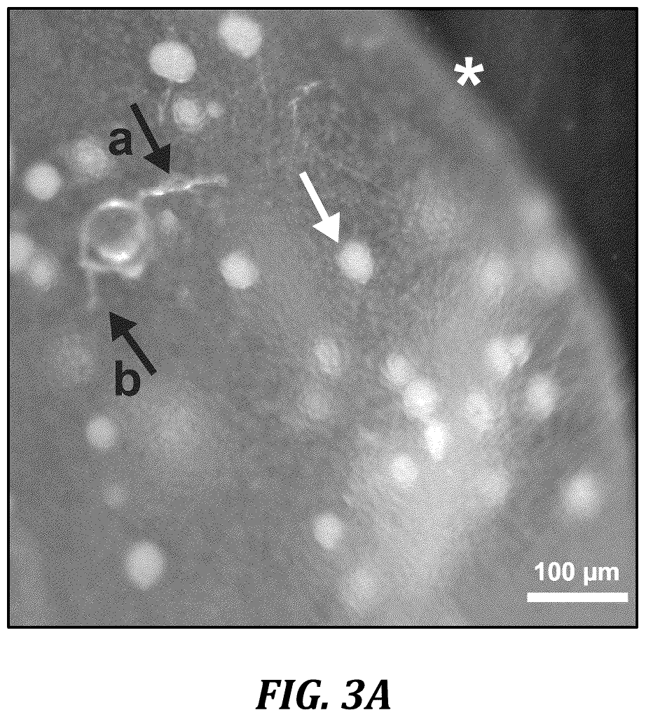

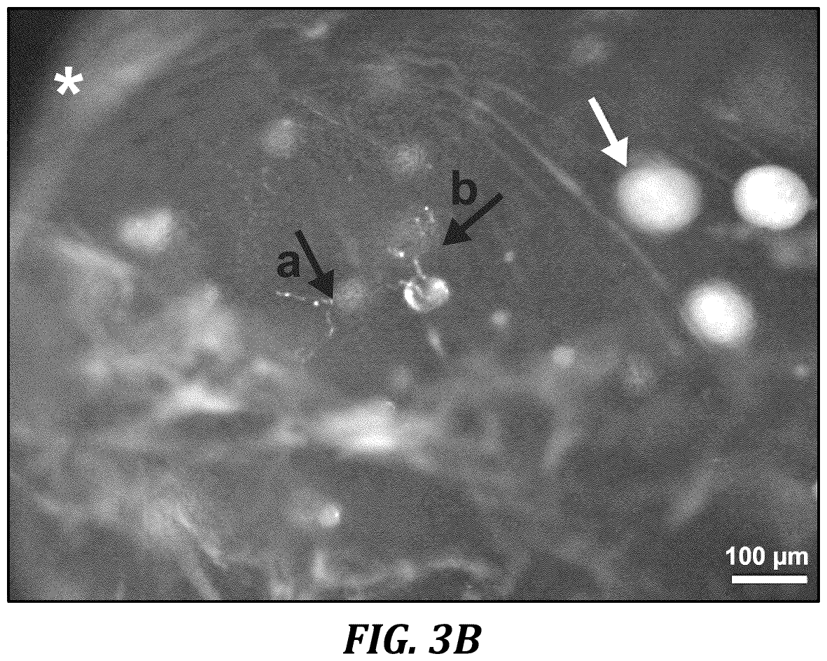

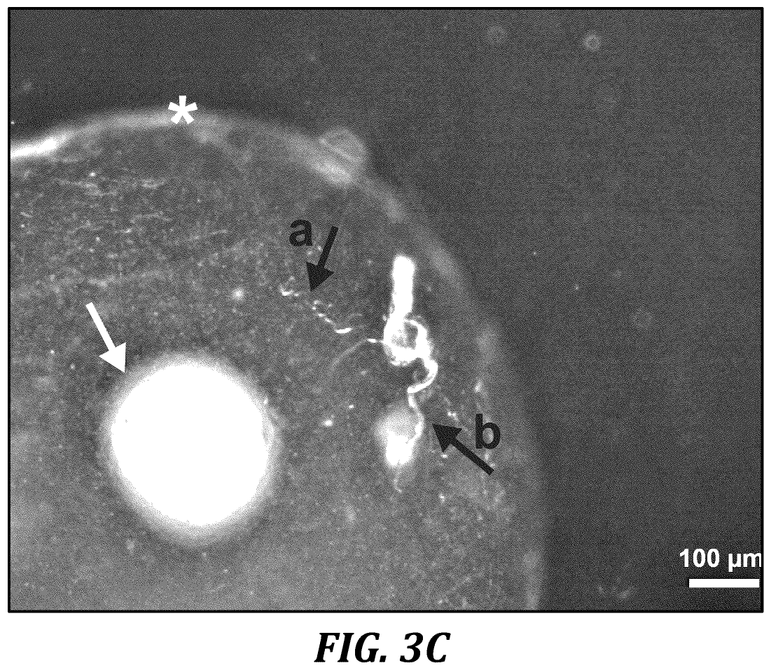

Images of successfully germinated arbuscular mycorrhizal spores of Rhizophagus intraradices, R. irregularis, and Funneliformis mosseae, on day 6 of incubation, shows hyphal branching and germ tube elongation (red arrows) in hydrogel beads with active bacterial A. brasilenses Sp7 (diazotrophic PGPB) colony growth (white arrows). Such microscope images are shown in FIGS. 3A-3C.

### Example 3

Emergence and Early Growth Stages of Plants Treated with the Inoculant Composition Nitrogen fixing bacteria (N-fixers), phosphate solubilizing bacteria (P-solubilizers), and arbuscular mycorrhizal fungi (AMF) were co-entrapped in alginate beads and applied as a biofertilizer to wheat (Triticum aestivum) and tomato (Solanum lyopersicum) to test if the hydrogel biofertilizer benefitted early developmental stages (e.g., emergence, height, leaf count) and overall growth of both crop species. The hydrogel biofertilizer was applied when germinated seeds were planted and again 35 days after growth. Controls that did not receive hydrogel biofertilizers were included for both species, to compare the differences in growth parameters.

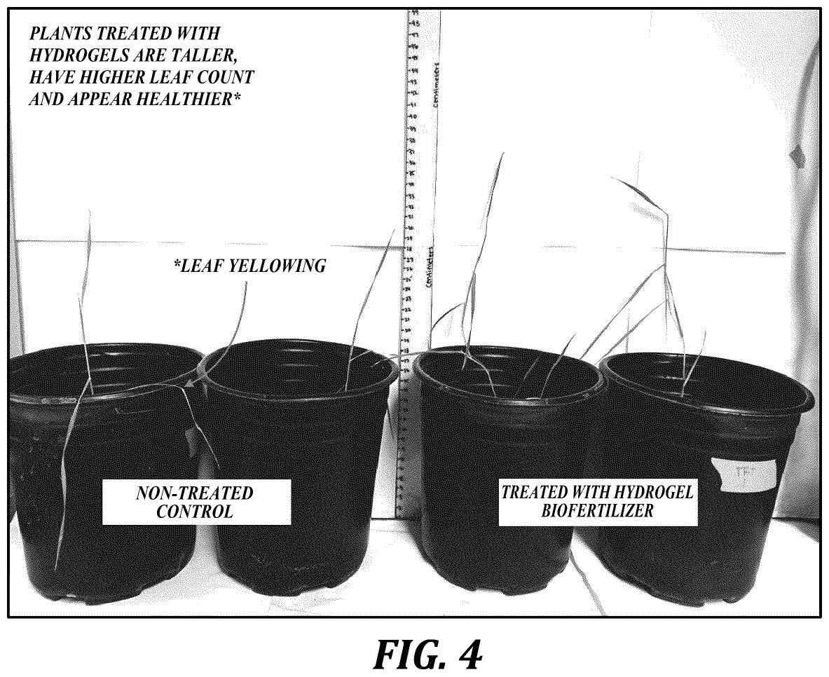

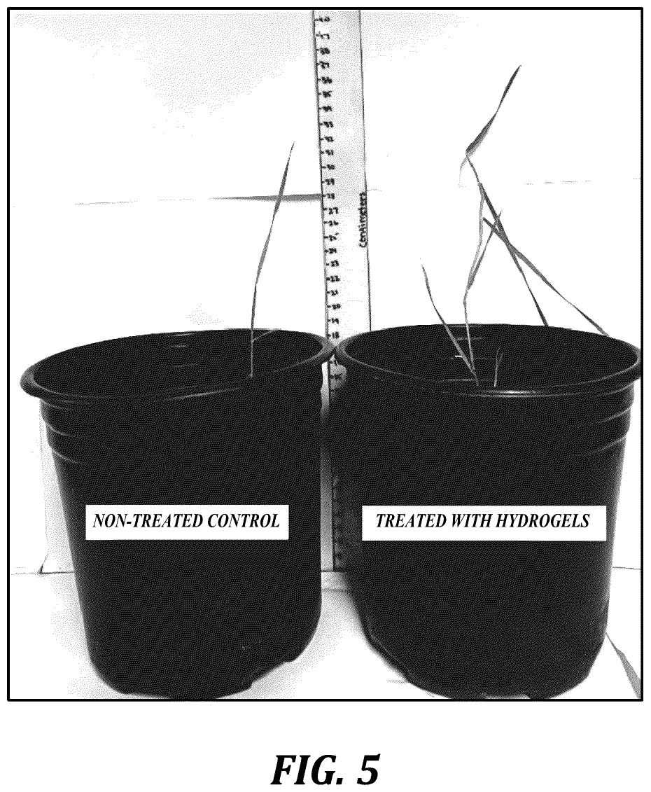

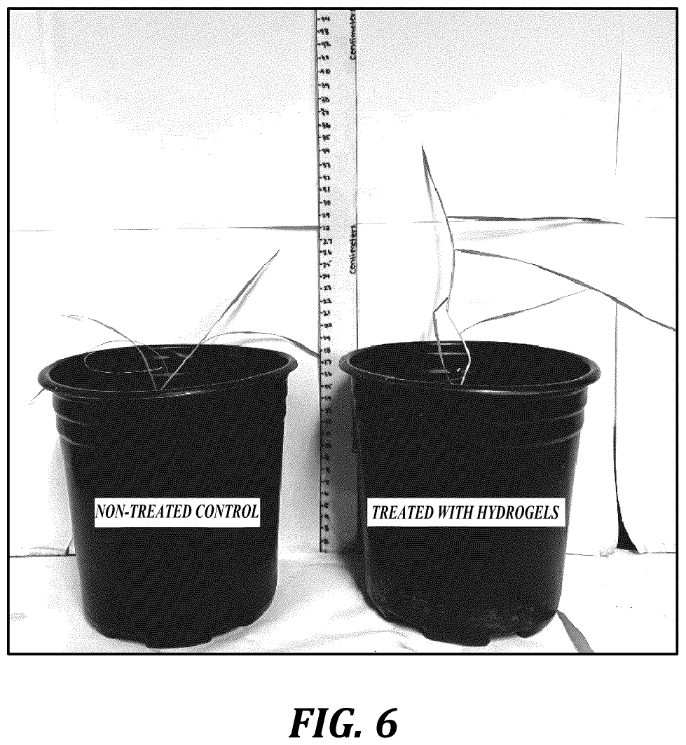

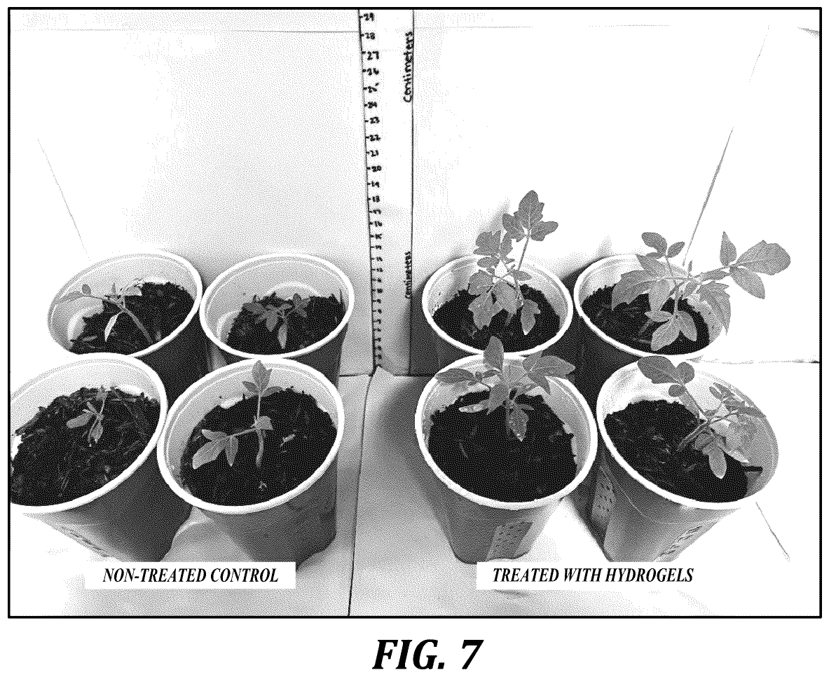

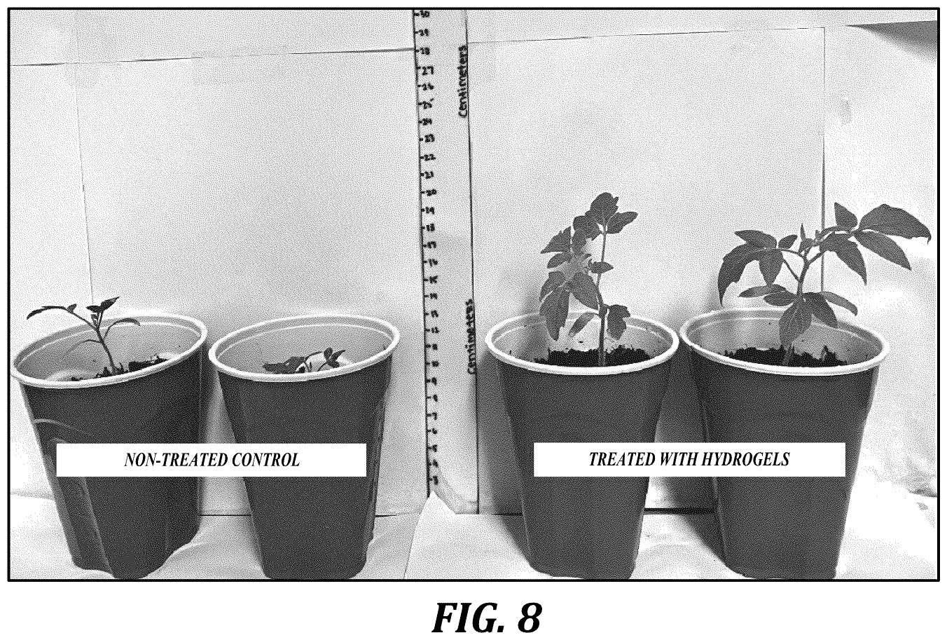

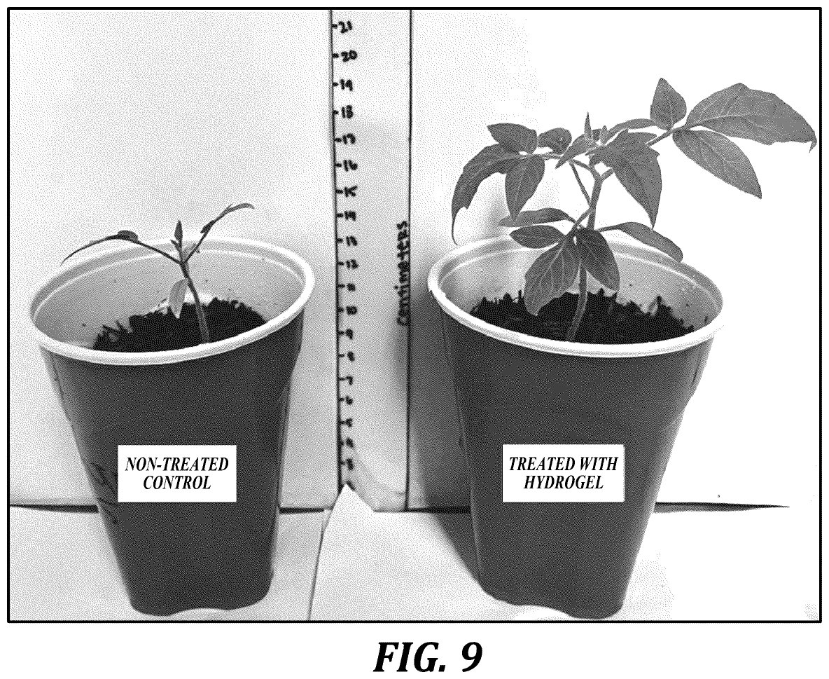

Wheat plants, shown in FIGS. 4-6, and tomato plants, shown in FIGS. 7-9, treated with the biofertilizer demonstrated uniform emergence after planting, whereas non-treated controls showed a lag in emergence.

All hydrogel treated wheat plants showed uniform emergence 2 days after planting, but the non-treated controls did not demonstrate uniform emergence. On day 2, only 70% of non-treated wheat seeds had emerged, and the remaining controls did not emerge until day 4.

All hydrogel treated tomatoplants showed uniform emergence 2 days after planting, but the non-treated controls did not demonstrate uniform emergence. On day 2, only 60% of non-treated tomato seeds had emerged, by day 3, 80% had emerged, and the remaining controls did not emerge until day 5.

Wheat plants, shown in FIGS. 4-6, and tomato plants, shown in FIGS. 7-9, treated with the biofertilizer also demonstrated improved plant growth parameters including plant height and leaf count.

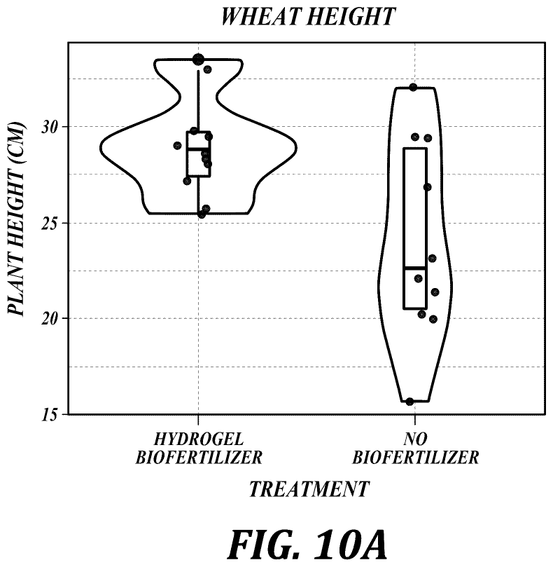

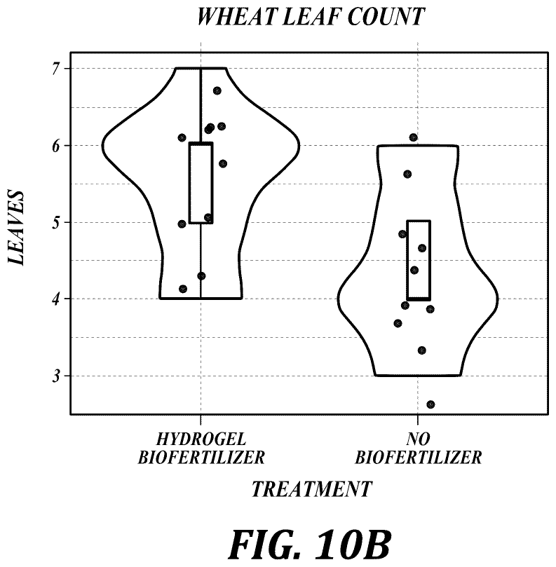

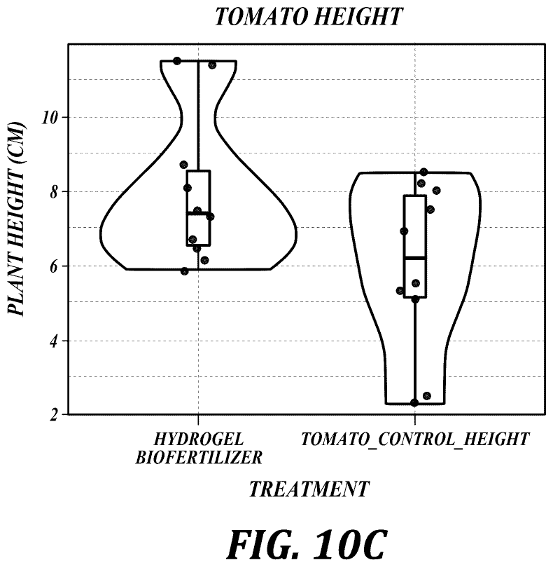

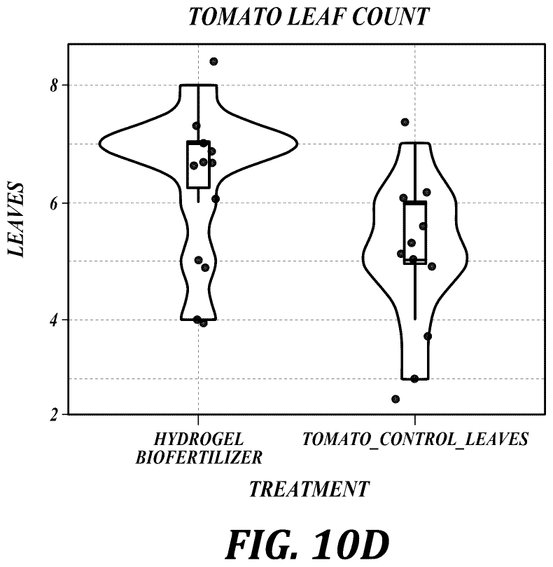

All hydrogel treated wheat plants demonstrated a significant improvement in plant height (FIG. 10A, P<0.05) and leaf count (FIG. 10B, P<0.05). Additionally, the non-treated wheat plants demonstrate signs of nitrogen deficiency (i.e., lower leaves yellowed and died off as the plant allocated what nitrogen was available to new growth).

All hydrogel treated tomato plants demonstrated a significant improvement in plant height (FIG. 10C, P<0.05) and leaf count (FIG. 10D, P<0.05).

This example demonstrates that the hydrogel biofertilizer containing N-fixers, P-solubilizers, and AMF benefit emergence and early growth stages of both crops.

Further, wheat plants treated with the hydrogel inoculant composition started to form tillers (Feeke's growth stage 3.0-4.0), whereas none of the non-treated controls formed tillers (Feeke's developmental stage 1.0-2.0). Seventy percent of wheat plants that received biofertilizer reached the tillering stage, compared to 10% of controls. This demonstrates that the biofertilizer continued to benefit the growth stages of wheat past the emergence stage.

In addition to testing the hydrogel biofertilizer on the development and growth of wheat and tomato, the hydrogel biofertilizer was applied to a small sample size of germinated sweet corn (Zea mays) seedlings. The emergence was compared to non-treated controls. 100% of corn plants treated with the biofertilizer showed uniform emergence, whereas only 33% of the non-treated controls emerged. Prior to planting, all corn seeds demonstrated uniform germination. However, once planted in soil, the hydrogel biofertilizer aided corn plants in emergence and prevented corn seedling die-off.

### Example 4

### Inoculant Composition Activity for Soil Remediation

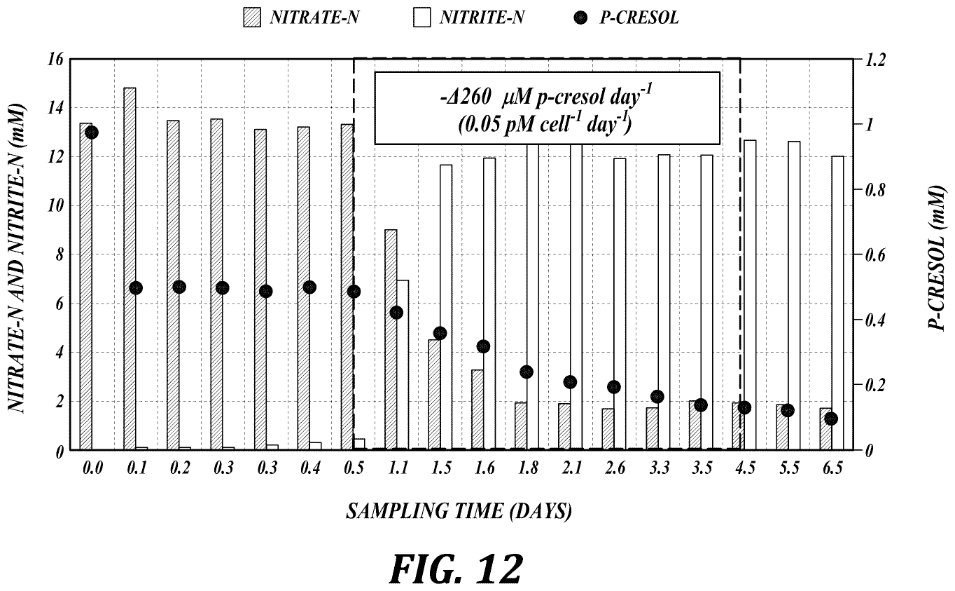

Bacteria was cultivated which degraded pollutants contaminating soils. Such pollutants included explosives and explosive by-products, such as those from 2,4,6-trinitrotoluene (TNT). Since work with TNT directly is unsafe, the typical (hardly degradable) intermediate metabolite p-cresol, that accumulates during degradation of TNT, was used. Bacteria such as Desulfobacula phenolica, Goebacter, and Thauera aminoaromatica was used in the inoculant composition hydrogel bead to degrade p-cresol. FIG. 12 shows p-cresol concentration at various sampling times after exposure of the inoculant composition comprising T. aminoaromatica.

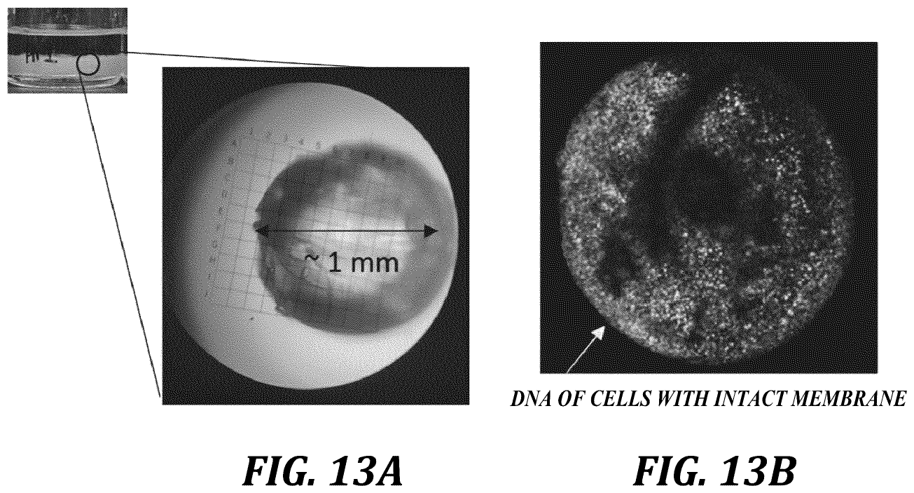

Nitrate is a common contaminant after synthetic fertilizer use, and is also a problem in soils contaminated with explosives that are rich in nitrogen, such as TNT. FIG. 12 shows comparison of the nitrate-N, nitrite-N, and p-cresol concentration at various sampling times after exposure of the inoculant composition comprising T. aminoaromatica. FIGS. 13A and 13B show images of PEGDMA of T. aminoaromatica under a light microscope (FIG. 13A) and under a CLSM microscope (FIG. 13B).

### Example 5

### Inoculant Compositions Comprising Other N-cycling Bacteria

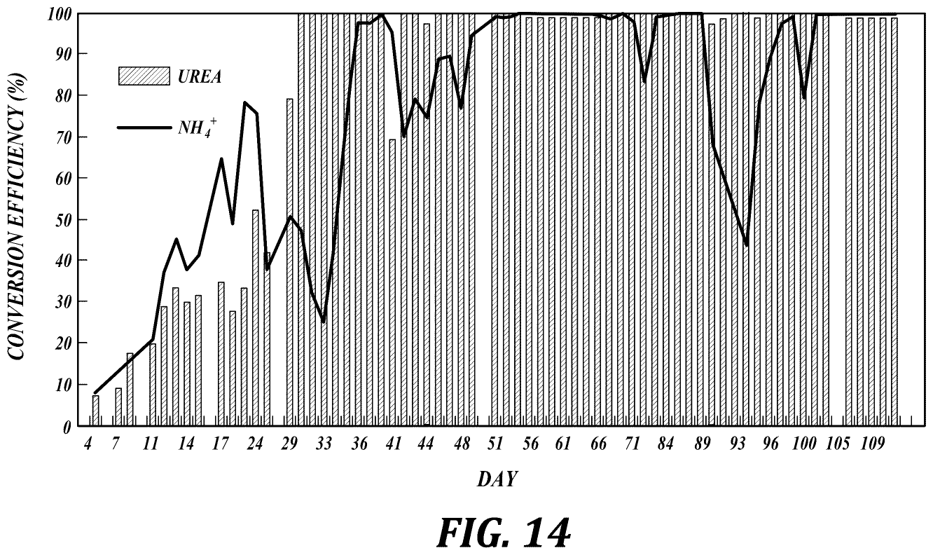

Various other N-cycling bacteria were utilized for nitrification (examples include ammonium oxidizing bacteria, bacteria, nitrate oxidizing bacteria, and complete ammonium oxidizers) and denitrification (heterotophic and autotrophic) in hydrogels to supplement nitrogen removal in over fertilized soils. In addition, urease active strains can also be utilized to convert naturally occurring urea to ammonia that can be better accessed by plants. Data from an inoculant composition comprising ammonium oxidizing bacteria (N. lacus) and Anammox (Anammox brocardia), which simultaneously remove urea and ammonium through conversion to nitrogen gas, is shown in FIG. 14.

It will be appreciated that, although specific embodiments of the disclosure have been described herein for purposes of illustration, various modifications may be made without deviating from the spirit and scope of the disclosure.

1. An inoculant composition comprising:
a hydrogel bead, a microbial consortia, and a fungi, wherein the microbial consortia and the fungi are in contact with the hydrogel bead.

2. The inoculant composition of claim 1, wherein the hydrogel bead is an alginate bead.

3. The inoculant composition of claim 1, wherein the microbial consortia comprises autotrophic microbes, heterotrophic microbes, or a combination thereof, and wherein the autotrophic and heterotrophic microbes comprise prokaryotes, eukaryotes, or a combination thereof.

4. The inoculant composition of claim 1, wherein the microbial consortia comprises Azospirillum brasilense, Azotobacter vinelandii, Azotobacter chroococcum, Enterobacter spp., Klebsiella spp., Flavobacterium spp., Pseudomonas spp., Enterobacter ludiwgii, Alcaligenes spp., Bacillus spp., Nitrosomonas spp., Nitrosococcus spp., Nitrospira spp., Nitrobacter spp., Nitrospina spp., Nitrococcus spp., Nitrotoga spp., Nitrolancaea spp., Nitrosopumilus spp., Nitrososphaera spp., Nitrobacter spp., or a combination thereof.

5. The inoculant composition of claim 1, wherein the fungi comprises arbuscular mycorrhizal fungi, ectomycorrhizal fungi, ericoidal mycorrhizal fungi, plant growth promoting fungi, decomposer fungi, or a combination thereof.

6. The inoculant composition of claim 5, wherein the arbuscular mycorrhizal fungi comprises Acaulospora spp., Funneliformis spp., Rhizophagus spp., Glomus spp., Claroideoglomus spp., Gigaspora spp., Scutellospora spp., Diversispora spp., or a combination thereof.

7. The inoculant composition of claim 1, wherein the microbial consortia comprises N-fixing bacteria, P-solubilizing bacteria, nitrifying bacteria, urease active bacteria, archaea, or a combination thereof.

8. The inoculant composition of claim 1, wherein the hydrogel bead has a diameter, and the diameter is about 0.2 mm to about 10 cm.

9. The inoculant composition of claim 1, wherein the microbial consortia and the fungi are encapsulated within the hydrogel bead.

10. The inoculant composition of claim 1, wherein the hydrogel bead further comprises water, one or more nutrient, or a combination thereof.

11. The inoculant composition of claim 1, wherein the hydrogel bead is comprised of an amount effective to contact the microbial consortia and the fungi; the microbial consortia is comprised of an amount effective to release one or more nutrient to a plant; and the fungi is comprised of an amount effective to associate with a plant root and increase plant access to the one or more nutrient.

12. The inoculant composition of claim 10, wherein the one or more nutrient comprises phosphorus, potassium, nitrogen, iron, magnesium, copper, a vitamin, or a combination thereof.

13. The inoculant composition of claim 1, wherein the hydrogel bead is comprised of an amount effective to contact the microbial consortia and the fungi; the microbial consortia is comprised of an amount effective to degrade one or more chemical compounds; and the fungi is comprised of an amount effective to degrade one or more chemical compounds.

14. The inoculant composition of claim 13, wherein the chemical compounds are present due to a chemical contamination, spill, leakage, explosion, application, synthetic production, natural production, or a combination thereof.

15. The inoculant composition of claim 1, wherein the inoculant composition is administered to a plant, a part of a plant, a medium in contact with a plant, or medium in need thereof.

16. The inoculant composition of claim 1, wherein the hydrogel is biodegradable or not biodegradable.

17. The inoculant composition of claim 1, further comprising an excipient suitable for applying the inoculant composition.

18. The inoculant composition of claim 1, further comprising one or more seed, wherein each of the one or more seed is optionally encapsulated.

19. A method of increasing nutrient acquisition in a plant in need thereof, the method comprising:
generating an inoculant composition for a treatment of a plant, a part of a plant, a medium in contact with a plant, or a combination thereof, wherein the inoculant composition comprises an effective amount of a hydrogel bead, an effective amount of a microbial consortia, and an effective amount of a fungi, and wherein the microbial consortia and the fungi are in contact with the hydrogel bead; and
applying the inoculant composition to the plant, a part of a plant, a medium in contact with a plant, or a combination thereof, or a medium in proximity to a plant wherein the plant can access the inoculant composition from the medium.

20-26. (canceled)

27. A method of degrading chemical compounds from a medium comprising a chemical compound contaminant, the method comprising:
generating an inoculant composition for a treatment of a medium in need thereof, wherein the inoculant composition comprises an effective amount of a hydrogel bead, an effective amount of a microbial consortia, and an effective amount of a fungi, wherein the microbial consortia and the fungi are in contact with the hydrogel bead; and
applying the inoculant composition to the medium in need thereof.

28-30. (canceled)
